(19) United States
(12) Patent Application Publication
(10) Pub. No.: US 2026/0017740 A1
(43) Pub. Date: Jan. 15, 2026

(54) METHOD AND SYSTEM FOR ASSIGNING CREDIT FOR PRIOR LEARNING

(71) Applicant: KnowMeQ Incorporated, Etobicoke (CA)

(72) Inventors: Matt FORAN, Etobicoke (CA); Wesley ROSE, Etobicoke (CA); Anemily MACHINA, Etobicoke (CA); Ali KOKULU, Etobicoke (CA)

(21) Appl. No.: 19/265,187

(22) Filed: Jul. 10, 2025

Related U.S. Application Data
(60) Provisional application No. 63/669,345, filed on Jul. 10, 2024.

(51) Int. Cl. G06Q 50/20

(52) U.S. Cl. CPC G06Q 50/2057

(57) ABSTRACT

The disclosure is directed at a method and system for assigning credit for prior learning where the learning may be academics, from working or from life experience. In some embodiments, the disclosure may be seen as a system for awarding credit for prior learning. The disclosure assists administrators accelerate the process of reviewing applications and helps students immediately know how their experience would translate to course credits.

### Cross-reference to other applications

The disclosure claims priority from U.S. Provisional Application No. 63/669,345 filed Jul. 10, 2024, which is hereby incorporated by reference.

### FIELD

The disclosure is generally directed at the field of academics, and more specifically, at a method and system for assigning credit for prior learning.

### BACKGROUND

In the world of academics, students transfer to different schools on a regular basis. Also, there are mature individuals who may or may not have formal post-secondary education who also consider going back to school after they have been part of the work force for a period of time. As a mature learner, who is starting or returning for further education or learning, there may be overlap in the courses that they previously took, or they may have attained direct experience related to specific post-secondary courses through their current or previous work, apprenticeship and/or volunteer experience that may overlap with the courses they are hoping to take. Instead of making the student re-take courses that they may have already mastered, there is a need to assist students to accelerate their time at the school by providing credit for to the student for their previous life experience.

Therefore, there is provided a novel method and system for assigning credit for prior learning.

### SUMMARY

The disclosure is directed at a method and system for assigning credit for prior learning where the learning may be from academics, from working or from life experience. In some embodiments, the disclosure may be seen as a system for awarding credit for prior learning in order to assist a prospective curriculum decision. In some embodiments, the disclosure assists academic institution administrators to accelerate the process of reviewing applications and helps students immediately know how their experience would translate to course credits.

The disclosure is directed at a method and system for presenting recommended course credits that an individual or student can qualify for exemption from their prior academic learning, work or volunteering experiences. In one embodiment, the disclosure compares a student's academic history with respect to prospectives courses or a prospective curriculum that the student is interested in pursuing or taking and applies or assigns credit for the prospective courses or curriculum to the student based on the prior learnings of the student. In other embodiments, the disclosure compares a student's working or volunteer experiences with respect to prospective courses or a prospective curriculum that the student is interested in pursuing or taking and applies or assigns credit to the student based on the prior working or volunteering experience of the student. In yet other embodiments, the disclosure compares a student's academic, working and/or volunteering experience with respect to courses or curriculum that the student is interested in pursuing or taking and applies or assigns credit to the student based on the prior academic history or working and volunteering experience of the student.

In one aspect of the disclosure, there is provided a method for determining credit for prior learning for an individual including retrieving at least one of a work history, volunteer history and/or academic history for the individual; comparing the at least one of work history, volunteer history and/or academic history for the individual with a list of courses from a prospective course curriculum; determining if any of the at least one of a work history, volunteer history and/or academic history for the individual are equivalent to a course outcome for any of the list of courses from the prospective course curriculum; and assigning credit for prior learning to any course with an equivalent to the individual's work history, volunteer history and/or academic history.

In another aspect, comparing the at least one of work history, volunteer history and/or academic history for the individual with a list of courses from a prospective course curriculum includes parsing the at least one of work history, volunteer history and/or academic history for the individual; generating embeddings based on words and sentences within the at least one of work history, volunteer history and/or academic history for the individual; and comparing the embeddings with predetermined terms associated with the list of courses from the prospective course curriculum. In a further aspect, comparing the embeddings with predetermined terms associated with the list of courses from the prospective course curriculum includes determining a similarity between the embeddings and the predetermined terms.

In yet another aspect, determining a similarity between the embeddings and the predetermined terms includes calculating a cosine similarity score between the embeddings and the predetermined terms. In yet a further aspect, assigning credit for prior learning to any course with an equivalent to the individual's work history, volunteer history and/or academic history includes displaying results of equivalence comparison between the at least one of a work history, volunteer history and/or academic history for the individual and the course outcome for any of the list of courses from the prospective course curriculum; receiving input confirming equivalence confirmation; and assigning credit for prior learning based on input received. In a further aspect, assigning credit for prior learning to any course with an equivalent to the individual's work history, volunteer history and/or academic history includes assigning credit for prior learning if it is determined that there is equivalence between the individual's work history, volunteer history and/or academic history and course outcomes for any of the list of courses from the prospective course curriculum. In another aspect, the disclosure further includes updating the prospective course curriculum based on credit for learning determination.

### BRIEF DESCRIPTION OF THE DRAWINGS

The foregoing and other features and advantages of the disclosure will be apparent from the following description of embodiments thereof as illustrated in the accompanying drawings. The accompanying drawings, which are incorporated herein and form a part of the specification, further serve to explain the principles of the disclosure and to enable a person skilled in the pertinent art to make and use the invention. The drawings are not to scale.

FIG. 1 is a schematic diagram showing a system for assigning credit for prior learning in its operational environment;

FIG. 2a is a schematic diagram of a system for assigning credit for prior learning;

FIG. 2b is a schematic diagram of a database for use with a system for assigning credit for prior learning;

FIG. 3 is a flowchart showing a method of assigning credit for prior learning;

FIG. 4 is a flowchart showing one embodiment of a method for using the assigned credit for prior learning; and

FIGS. 5a to 5c are flowcharts showing another method of assigning credit for prior learning.

### DETAILED DESCRIPTION OF THE EMBODIMENTS

The disclosure is directed at a method and system for assigning credit for prior learning. The prior learning may be in the form of an individual's previous academic schooling, any learning(s) from previous work experiences or any learning(s) from volunteer experiences.

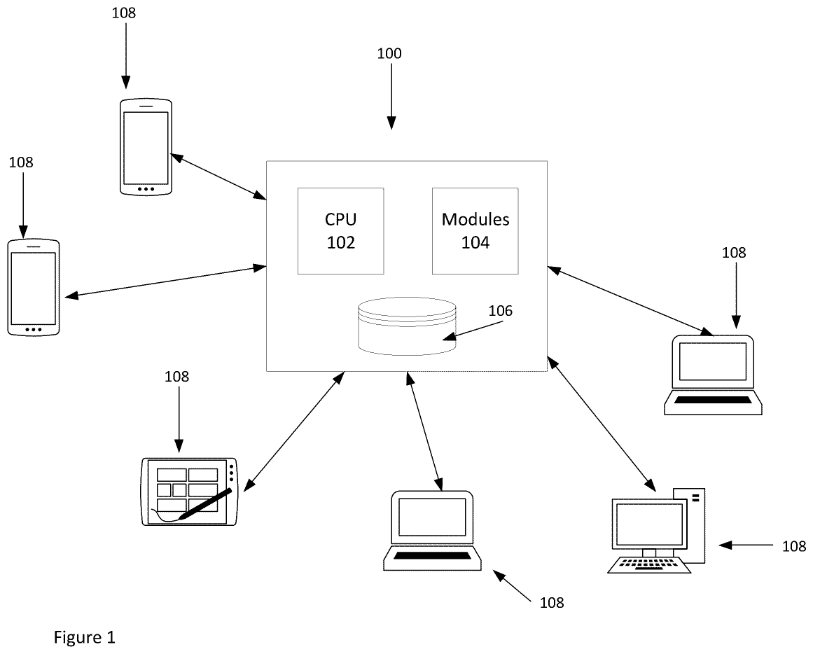

Turning to FIG. 1, a schematic diagram showing system for assigning credit for prior learning in its operational environment is shown. The system 100 includes a central processing unit (CPU) 102 or processor that includes a set of modules 104 that perform different functionality to implement the system for assigning credit for prior learning. It is understood that the modules 104 may perform other functionalities that do not involve the system for assigning credit for prior learning. The system 100 may further include a database 106 for storing information, such as, but not limited to, student academic histories, course curriculums and course outlines or syllabi, course descriptions, course codes, course learning outcomes for courses from different academic institutions, a correspondence between courses and course curriculums between different academic institutions, applicant occupation and education information, enriched education data, enriched occupation data, educational or academic institution course learning outcome data and/or prospective student identification information such as name, resume details. In some embodiments, the database 106 may be part of the system and in other embodiments, the database may be external to the system 100.

In operation, the system 100 is in communication with a set of communication devices 108 which are associated with different users of the system. These users may include current students; prospective students; academic institution personnel; employment professionals; academic counsellors and the like. The communication devices 108 may include, but are not limited to, tablets, smartphones, laptops and/or desktop computers or similar devices. Communication between the communication devices 108 and the system 100 may be over a public network, such as the Internet or a private network.

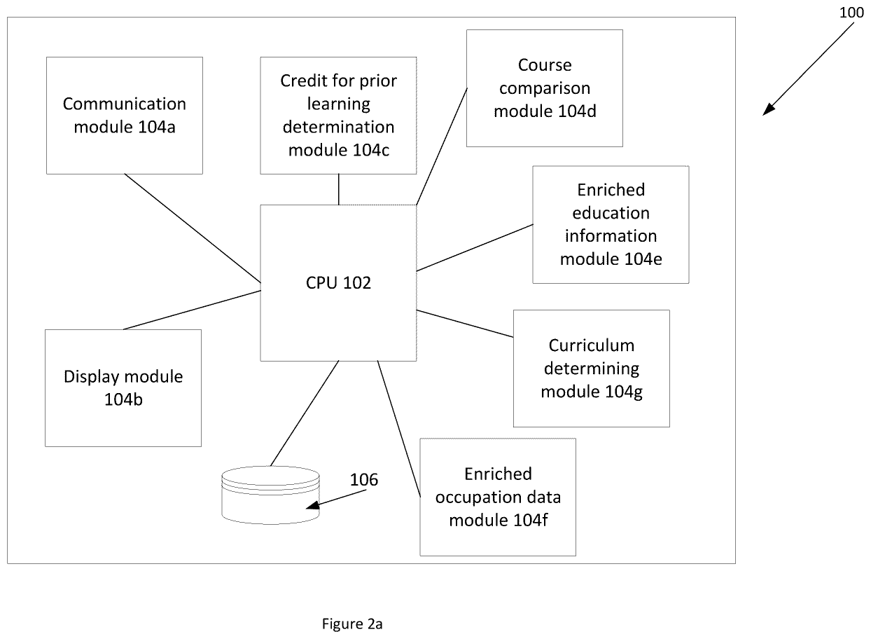

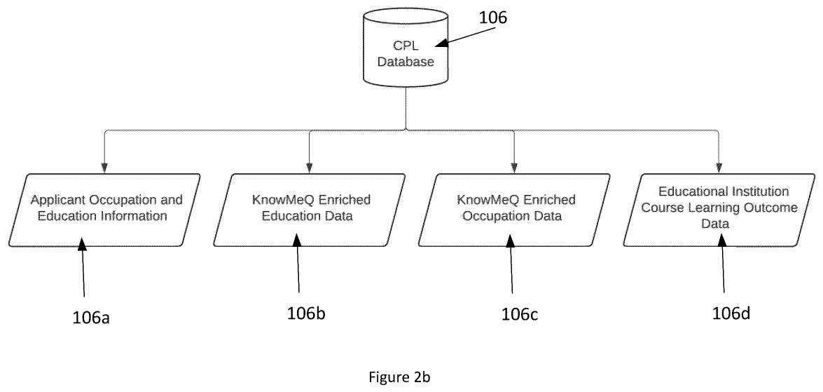

Turning to FIG. 2a, a schematic diagram of the system is shown. As described above, system 100 includes the CPU 102, the set of modules 104 for performing the functionality of assigning credit for prior learning and the database 106. In the current embodiment, the set of modules 104 includes a communication module 104a, a display module 104b, a credit for prior learning determining or determination module 104c, a course comparison module 104d, an enriched education information module 104e, an enriched occupation data module 104f and a courses or curriculum determining module 104g which may include a post-secondary program component.

The communication module 104a provides the functionality enabling the system 100 to communicate with the communication devices 108 or other computer technology components such as an external server (not shown) or an external database (not shown). The communication module 104a may communicate with the communication devices 108 using known communication protocols. The communication module 104a may also store information to and/or retrieve information from the database 106. The display module 104b may provide the functionality to generate images or screens that are displayed on the communication devices 108. For example, the display module 104b may receive the information relating to credit for prior learning that has been determined by the system 100 and then generates or provides a display that is communicated to the communication device 108 via the communication module 104a so that a user of the communication device 108 can review the determined credit for prior learning on their associated communication device 108. It is understood that other displays to convey other types of digital information may be generated by the display module for transmission to the different communication devices 108.

The credit for prior learning determination module 104c provides the functionality to determine how a student's prior learning such as in the form of academic and/or work and/or volunteering history can be applied to or assigned as credits for an academic institution's curriculum or courses that a student is interested in applying for or attending. The credit for prior learning determination module 104c retrieves a student's academic history, work history, volunteer history or other relevant information from the database 106 or from an external database to determine the student's credit for prior learning. In some embodiments, the student's academic history may include the student's prior academic courses and academic institution(s) they attended. In some embodiments, the work history may include a listing of all the employment positions that the student has held within the work force and includes descriptions of the task or tasks that the student performed when holding those employment positions. In some embodiments, the volunteer history may include volunteer positions which the student has held that may including a listing of the tasks the student performed when holding the different volunteer positions. In some embodiments, the credit for prior learning determination module 104c articulates the student's academic, work and/or volunteer experiences from discrete skills and competencies to post-secondary programs and corresponding learning outcomes from post-secondary courses. In other words, the credit for prior learning determination module 104c compares the learning outcomes for an academic institution's curriculum or courses that a student is interested in applying for or attending and matches them with learnings that the student has picked up through academics, work and/or volunteer opportunities.

The course comparison module 104d may include a repository or storage medium that stores course listings from different academic institutions and, in some embodiments, may determine or store a list of equivalent courses between these academic institutions to assist in the credit for prior learning determination. For example, the credit for prior learning module 104c may access the course comparison module 104d to determine if a course in the student's prospective course curriculum has an equivalent in the student's academic history whereby credit for the student's academic history can be assigned for the equivalent course in the prospective course curriculum. In another example, the course comparison module 104d may determine or may have already determined that a third-year accounting course associated with a first academic institution is equivalent to or sufficient to assign credit for a first-year economics course associated with a second academic institution. In other words, if a student has taken the third-year accounting course from the first academic institution and is applying for a program at the second academic institution that includes a requirement to take the first-year economics course, the credit for prior learning module 104c may recommend or determine that the student should be credited for the first-year economics course based on the fact that the third-year accounting course at the first academic institution is equivalent as determined or pre-determined by the course comparison module 104d.

The enriched educational information module 104e performs the functionality to review the courses that are required for the student's prospective course curriculum and then determines, if these courses have any equivalent courses (as stored within the course comparison module 104d). If the enriched educational information module 104e determines there are equivalents to courses in the student's prospective course curriculum, the enriched educational module 104e may transmit a message or instruction to the course comparison module 104d to determine if the student has taken any of these equivalent courses and apply credit accordingly.

The enriched occupational data module 104f performs the functionality to connect discrete skills, competencies and complexity levels of the students work or volunteer experiences with educational experiences and course learning outcomes. These comparisons may be then processed by the system to determine if any of the student's work or volunteer experiences are eligible for credit for prior learning. In other embodiments, the system may display these comparisons to a user such that the user can make a determination if any of the student's work or volunteer experiences are eligible for credit for prior learning.

The curriculum determining module 104g performs the functionality to determine a student's updated prospective curriculum or academic program after all of the credit for prior learning has been applied or determined. In one embodiment, the curriculum determining module 104g may communicate with the credit for prior learning determination module 104c to retrieve or transmit the courses from the prospective course curriculum for which the student has received credit for based on their prior learning. The curriculum determining module 104g may then remove the credited courses from the student's prospective curriculum to generate an updated prospective curriculum for the student. This updated prospective curriculum may then be displayed to the student (such as via their communication device). In some embodiments, the system may communicate with the student to request the student to select further courses for their updated prospective curriculum (if needed).

As schematically shown in FIG. 2a, the CPU 102 is connected to each of the modules 104 and the database 106. Although not shown, the modules 104 may be connected to, or communicate with, the database 106 or with the other modules 104.

Turning to FIG. 2b, a schematic diagram of a database for use in a system for assigning credit for prior learning is shown. In the current embodiment, the database 106 may include different information or sections or sectors of digital information. The digital information may include, but is not limited to, applicant (student) occupation and education information 106a, enriched education data 106b, enriched occupation data 106c and education institution course learning outcome data 106d.

The applicant occupation and education information 106a may include resumes or curriculum vitae for all users or students of the system. The resumes or curriculum vitae include the academic, work and/or volunteer history of the different users to assist in the determination of credit for prior learning. The enriched education data 106b may include information or data that relates to different course curriculums that are offered by academic institutions. In some embodiments, the enriched education data 106b may include a list of the course curriculums for academic institutions and any equivalent courses from other or different academic institutions that may be seen as equivalents to the list of the course curriculums. The enriched education data 106b can also link the course curriculums to skills acquired from those courses. The enriched occupational data 106c may include information that aligns different work or volunteer experiences to skills acquired from these work or volunteer experiences and associates this information with different courses within a course curriculum or prospective course curriculum. The enriched occupational data 106c may be continually collected and stored as the disclosure evolves through the credit for prior learning determinations or the analysis of the enriched occupational data module.

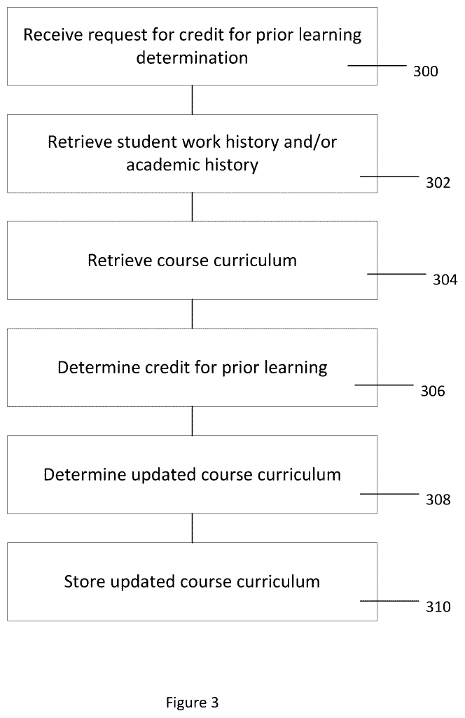

Turning to FIG. 3, a flowchart showing a method of assigning credit for prior learning is shown. It is assumed that the database has been pre-populated with digital data or digital information prior to the execution of this method. For example, the database may be populated with information such as described with respect to FIG. 2b.

Initially, the system receives a request to determine credit for prior learning for an applicant or student (300). This may be initiated by the student or by another individual such as, but not limited to, a labour action centre employee, an employment service staff-person, a registrar for an academic institution, or any other individuals who are involved academic institutions. As outlined above, it is assumed that the database includes the academic, work and/or volunteer history of the student and that this information has already been stored. However, if not, the system may request that the student provide any missing or relevant information relating to their academic, work or volunteer history for the credit for prior learning determination or assessment. If the request for the determination is being made by the student, the system may automatically request the student to input the required information. If the request is being made by another individual, the system may need to determine if the academic, work and/or volunteer history for the student of interest is stored in the system and then transmit a message to the student to input the required information if not stored. Once entered, the system may transmit a message to the original requesting individual indicating that the system is ready to perform the credit for prior learning determination.

The system then retrieves the student's work history, volunteer history and/or academic history from the database (302) to process this information. In one embodiment, this may be performed by the credit for prior learning determination module 104c. In some embodiments, the enriched education information module may process or parse the student's academic history to determine the type of courses the student has taken in their academic history and to determine course content and nature of the courses based upon their degree, diploma, certification designation completed.

In one embodiment, the system may include a dataset that includes a mapping of different academic programs from different academic institutions to courses available from other academic institutions. Alternatively, the system may include a dataset that includes a mapping of different academic programs with expected skills that are achieved if that academic program is completed by the student. The system may then use NLP (natural language processing) to determine the program that was completed by the student as listed in their academic history and the courses associated with the program. For example, if a student has completed a computer science degree, it is expected that the student has computer programming skills or competency.

The enriched occupation data module may process or parse the student's work and/or volunteer history to determine the type of work and/or volunteer experience the student has. For example, the student may have worked or volunteered as an accountant such that their experience would include an understanding of economics and other similar business type courses. Parsing of this digital data enables the system to associate the student's prior learning with predetermined standard terms or course descriptions that are stored by the system, such as, but not limited to, in a look-up table.

The system reads and collates the student's skills, refencing their academic, work and/or volunteer experiences or histories and retrieves post-secondary program lists and corresponding course outlines from the database (304). This may be performed using a many-to-many matching methodology. In some embodiments, the disclosure recommends normalization, standard or previously stored choices based on the academic, work and/or volunteer histories. In some embodiments, the system may review course learning outcomes (goals of academic courses) which represent demonstrable skills that are taught or learned in courses, such as post-secondary courses. A course outline module stores the course description, course code and learning outcome details with respect to different academic institutions. It may be seen as the reference rubric that determines eligibility for credit or prospective courses that the student is required to take for their prospective academic curriculum. In some embodiments, reading and collating may include parsing the student's prior learning. after parsing of the student's prior learning, the system may then retrieve and display previously stored choices (or terms) that are similar to the parsed terms in order to allow the student to select which previously stored choices best represent their different prior learning experiences or history. Alternatively, the parsing may be performed at a later stage or it may be performed at multiple stages.

The system, such as via the credit for prior learning determination module 104c, then determines the credits the student should receive for prior learning (306). In one embodiment, the system compares the student's academic, work and volunteer history with the prospective course curriculum. In one embodiment, this may be performed by retrieving information from the course comparison module 104d which stores information about which courses from other academic institution are equivalent to courses in the prospective course curriculum from a second academic institution and then determines which of the student's previously completed academic courses are equivalent to courses in the prospective course curriculum. The comparison may be performed using a look-up table or the comparison may be performed by parsing words or sentences in the student's academic history and then associating the parsed words and sentences with pre-defined or stored equivalents that are stored in the database. In one embodiment, this association between courses may be performed using embeddings generated for every word and sentence using a sentence-BERT framework. These sentence embeddings may then be used to calculate cosine similarity that can be used to infer syntactic similarity. The system may then determine based on the cosine similarity scores if credit should be assigned. Alternatively, the system may display the prospective courses that are closely associated with the student's prior learning so that a user can review and determine if credit should be applied. The user's decision may then be input to the system with respect to the credit that should be applied to the student's prior learning. This determination is then stored by the system.

After determining the credit for prior learning the student should receive, the system then determines an updated course curriculum for the student (308). In one embodiment, the determination is performed digitally by the system such as outlined above. In other embodiments, the equivalent courses may be displayed to an individual such that the individual can determine if credit should be applied and then enter this decision into the system so that the course curriculum can be updated accordingly. This may be performed by the course determining module. The updated prospective course curriculum can then be stored in the database (310).

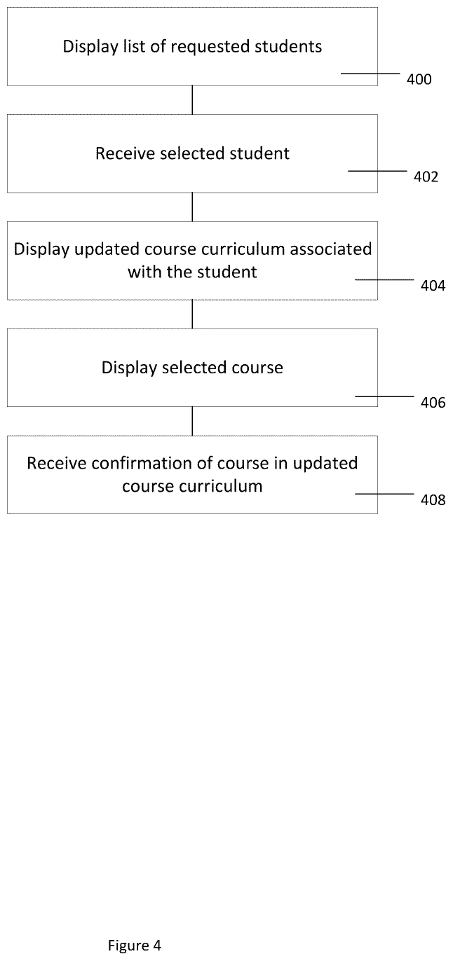

Turning to FIG. 4, a flowchart showing one embodiment of how the updated prospective course curriculum can be used is shown. After being stored in the database, the updated prospective course curriculum can be accessed by any user who is accessing the system.

In the current embodiment, the user can access the system to view all students who are applying to the academic institution. Once this request is received by the system, the system provides a list of the requested students (400). Upon review of the list, the user can then select a student which is received by the system (402). In other embodiments, a student can be selected by the system based on predetermined criteria. The system then displays the updated prospective course curriculum for the selected student to the user (404). The user can then select one of the courses in the updated prospective course curriculum for review (406). In one embodiment, the system displays the selected course such that the user can determine if the selected course is one that the student should include in their updated prospective course curriculum. In some embodiments, the updated prospective course curriculum determined by the system may not meet all predetermined criteria or may be updated for other reasons.

If the user agrees with the assessment of the system, the user can then confirm that the course should be part of the updated prospective course curriculum which is then received and acknowledged by the system (408).

In populating the database prior to the method of FIG. 3 being performed, the system may receive different inputs from the student that are parsed by the system using known technologies and methodologies such as, but not limited to, NPL. Examples of input may include but are not limited to, resumes, curriculum vitae, academic histories, previous work history, academic certificates, certificates for different professional development courses and the like.

In another embodiment, the system determines credit for prior learning recommendations based on the experience profile, normalization choices, occupation information, college program information, and course learning outcomes which may then be reviewed by an administrator to approve or reject the course credit recommendations.

In one embodiment, the system may be seen as a credit for prior learning model that includes an employment or job normalization model. The employment normalization model may be seen as a model that facilitates the alignment of a student's work experience to enriched work 106b or occupational 106c data (whereby different examples of the types of occupations are normalized). For example, the system may request the student to select from a list of normalized or predetermined occupations or education programs that best aligns with their work experience. To generate the list of possible occupations, the data or input collected about the student's different experiences is compared to different types of occupational and academic information that are stored in the system. For examples, the words in the title and/or description of the different sections of the student's academic, work and/or volunteer history are parsed, such as with NLP, and then compared with terms or words associated with the previously stored occupation and academic information.

This comparison is done using embeddings (real valued vectors) that are generated for each word and sentence provided by the student's academic, work or volunteer experiences. Cosine similarity is then calculated between the parsed student's experiences and the enriched occupational or education data (which, as outlined above represent previously stored information relating to different occupations or academic course curriculums, respectively). If the compared words, terms, phrases or parsed passages have a high cosine similarity, then semantic similarity is inferred.

In one embodiment, the model used to compute normalization embeddings is a sentence-BERT framework (all-mpnet-based-v2) that is fine tuned using multi-negative ranking loss (MNRL) based on the enriched occupational or academic data. In some embodiments, the top 5 normalization options are presented to the user, and the user selects what they believe is the best match to their experience. The enriched data sources related to each selected normalization choice can be compared with course learning outcomes to determine what courses if any the user is eligible to receive prior learning credit.

In another embodiment, the system may include an education normalization model. In one embodiment, the model used for the education normalization may be a sentence-BERT framework (all-mpnet-base-v2) for comparison of the student's academic history and the prospective course curriculum.

In yet another embodiment, the system may include a course recommendation model. In one embodiment, the model used for the course recommendation model may be a sentence-BERT framework (all-mpnet-base-v2) that is trained using a self-learning algorithm. The self-learning algorithm assumes that the course recommendation model is likely correct about its most confident predictions (cosine similarity>0.9) and least confident predictions (cosine similarity<0.05).

With respect to normalization details, the purpose of normalization is to map a user's experience (educational or occupational) to an enriched data source. In the case of occupational experience this facilitates standardizing occupations between different organizations or businesses that may have different titles or descriptions for similar occupations. In the case of education experience, normalization facilitates identifying similar programs, degrees, or certificates between institutions. During the normalization process users select from one of a list of normalization choices. To generate the list of possible normalization choices the data collected about the user's experience such as, but not limited to, title and description is compared to enriched data sources. As discussed above, this comparison is done using embeddings (real valued vectors) that are generated for each word and sentence provided by the user's work experience. Cosine similarity is then calculated between the users experience and the enriched occupational or education data. If two sentences have high cosine similarity, then semantic similarity is inferred. In some embodiments, the top 5 normalization options are presented to the user, and the user selects what they believe is the best match to their experience. The enriched data related to each selected normalization choice can then be compared with course learning outcomes to determine what courses if any the user is eligible to receive prior learning credit.

To accomplish the normalization of education experience, the system may include a dataset of degrees/diplomas into create learning outcomes, abilities, and skills associated with each degree/diploma.

With respect to course recommendation details, assigning a course recommendation score is done by first calculating the cosine similarity between each evidence sentence and course learning outcome. Cosine similarity is calculated using embeddings (real valued vectors). Embeddings are generated for all evidence sources. Evidence sources include the applicants resume sentences, a set of predetermined skills, a set of predetermined abilities, a set of predetermined tasks, college course mapping (CCM) description sentences, CCM generated learning outcomes, CCM generated skills, and CCM generated abilities. Embeddings for each evidence sentence are calculated using a course recommendation model. In one embodiment the model used for course recommendation is a Sentence-BERT framework (all-mpnet-based-v2). Cosine similarity is then calculated between the users experience embeddings and the course learning outcomes. A threshold is set to discard any evidence sentence that does not meet a certain cosine similarity score (this threshold is configurable).

In one specific embodiment cosine similarity scores are translated into rank scores: if a evidence sentences have the following cosine similarity scores 35, 54, 65, and 98 with a course learning outcome, the new rank scores would be 25, 50, 75, and 100 where 25 is the minimum or lowest rank score and is configurable. Next, only the top 10 (configurable) evidence sentences are kept for each learning outcome. In a specific embodiment, a credit for prior learning course is recommended if at most 20% (configurable) of learning outcomes for that course do not have evidence that meets that threshold. To calculate a course's overall score, the best score for each learning outcome is extracted and the average score per course may be calculated using the equation:

$$\frac{\sum S}{N}$$

where S is the best score for each learning outcome and N is the number of learning outcomes.

Next, the credit for prior learning module creates a list of courses with a score higher than 90 (configurable by institution) which may be capped to a predetermined number of courses. If there are less than five courses on this list, the module adds courses with a score of at least 80 (configurable by institution) until there are a predetermined number of courses or there are no more eligible courses to add. The system can then determine if a course has been identified in the list of recommended courses has an equivalent course that is eligible for a credit for prior learning determination. If not, the module will add the highest scoring credit for prior learning eligible course in place of the lowest scoring recommended course.

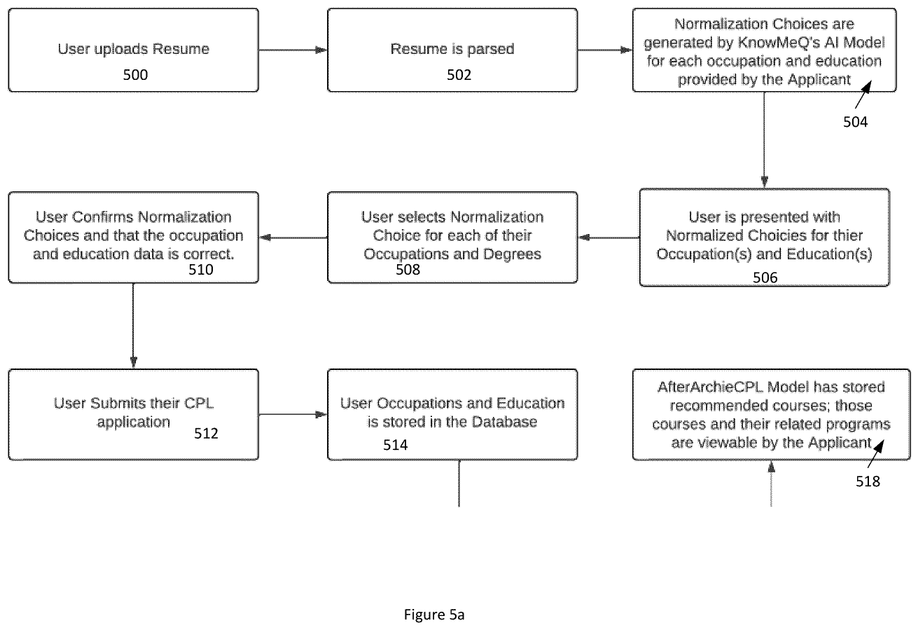

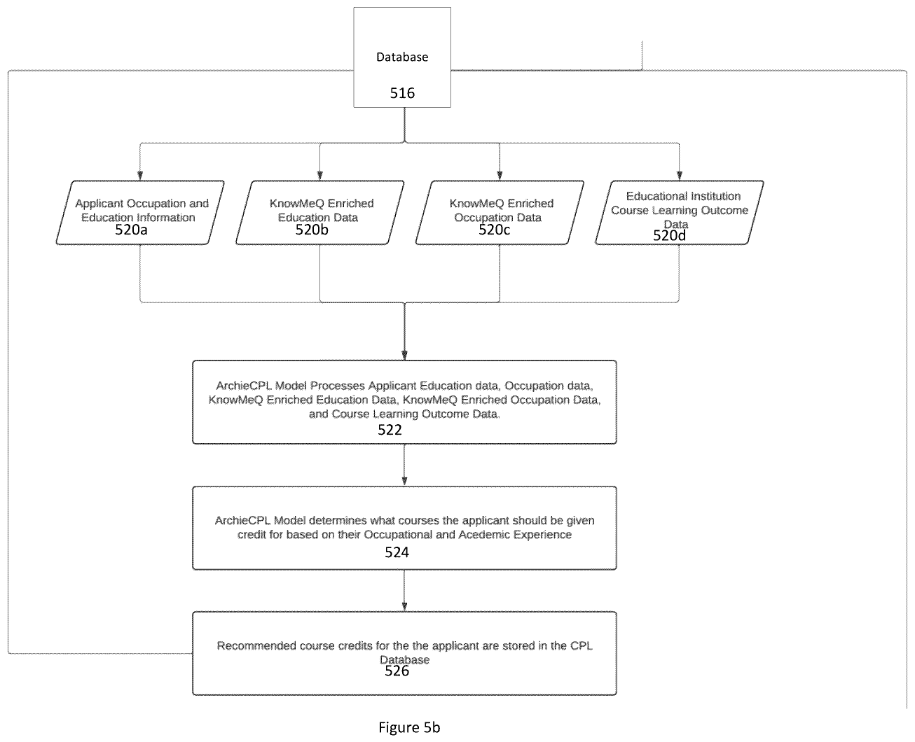

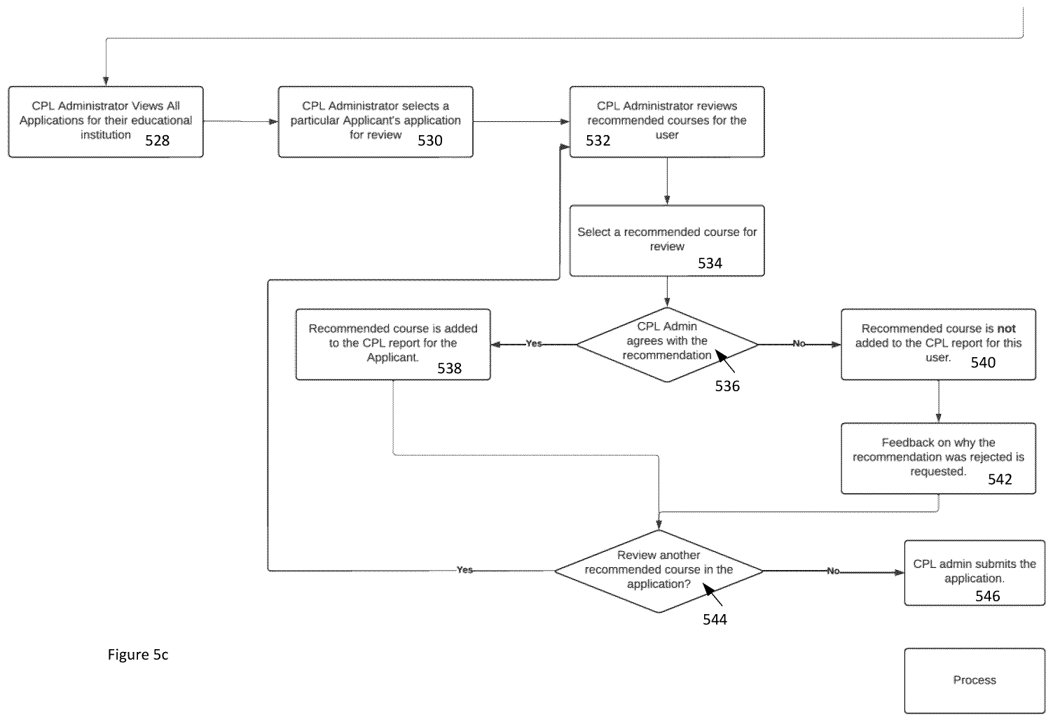

Turning to FIGS. 5a to 5c, another method of assigning credit for prior learning is shown. In this embodiment, the user uploads their resume (500) to the system which is then received and stored by the system. The system then parses the resume (502). The parsing of the resume may be to retrieve occupation, volunteer and/or education or academic information associated with the user. In some embodiments, the resume may be parsed prior to being stored by the system.

The system then provides normalization choices for each occupation and/or education (504) that was parsed from the user's resume in (502). As discussed above, the normalization choices may be seen as standardized terms that have been collected over time that associates different titled experiences under one collective term or normalization choice. For example, all experiences or courses relating to economics, financial and managerial accounting, taxation and/or auditing may be classified or normalized as accounting experience.

The system then provides the list of normalization choices to the user (506). In some embodiments, the system may only provide the normalization choices for the occupations; only provide the normalization choices for the education or may provide the normalization choices for both the occupation(s) and education. The user may then select the normalization choices for each of their occupations and education (or degrees) (508) which is received by the system and stored. The system may then prompt the user to confirm their normalization choices and that the occupation and education information is correct and then receives the response (510).

The system may then submit a credit for learning application (512). The system then stores at least one of the application, the occupation(s), the volunteer or the education information in a database (514). The system may then (when requested), display any courses that are related or combined with the user's education for the credit for prior learning application to the user (518). The related courses are described in more detail below.

As shown in FIG. 5b, the database 516 may store at least one of the student's occupation, volunteer and/or education information (520a), enriched education data (520b), enriched occupation data (520c) and/or education institution course learning outcome data (520d).

The system then processes all of the information that is stored in the database relating to the student or the student's application (522). In one embodiment, the system may be seen as an AI model that has been trained using other occupations or educational data retrieved from user interactions.

The system then determines which courses the user should be assigned credit (524) based on their occupational, volunteer and/or academic experience. The system then recommends course credits for the applicant or user that have been stored in the database (or were part of the credit for prior learning application) (526).

After the credit for prior learning application has been submitted, the system may display each of the applications to an administrator (528) or a person who has been designated by the academic institution to review the application. The system may then receive an application selection by the administrator (530). The system may then display the recommended courses that were determined in (520) with respect to the education entries in the user's resume (532). In other embodiments, the system may perform his comparison rather than receiving input decision from the administrator.

The system may then present recommended course for review (534) by an administrator or the system itself may make a determination. The administrator (or the system) may then determine if the evidence sentences identified sufficiently match the course learning outcomes (536). If it is, the recommended course is added to a credit for learning report for the user (538). If the learning outcomes of the course are not sufficiently met by the users evidence sentences, the system does not add the course to the credit for prior learning report (540). Feedback may then be provided as to why the courses are not seen as equivalents (542). The system may prompt the administrator if they wish to review another recommended course (544).

If there are further courses to review, the system returns to (530). If there are no more courses, the system then submits the credit for prior learning application (546).

The methods and systems described herein may be implemented in a high level procedural or object oriented programming or scripting language, or a combination thereof, to communicate with or assist in the operation of a computer system. Alternatively, the methods and systems for upgrading at least one seat may be implemented in assembly or machine language. The language may be a compiled or interpreted language. Program code for implementing the methods and systems for upgrading at least one seat may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for upgrading at least one seat may also be considered to be implemented by way of a non-transitory computer-readable storage medium having a computer program stored thereon. The computer program may comprise computer-readable instructions which cause a computer, or in some embodiments the processing unit, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for upgrading at least one seat may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method for determining credit for prior learning for an individual comprising:
retrieving at least one of a work history, volunteer history and/or academic history for the individual;
comparing the at least one of work history, volunteer history and/or academic history for the individual with a list of courses from a prospective course curriculum;
determining if any of the at least one of a work history, volunteer history and/or academic history for the individual are equivalent to a course outcome for any of the list of courses from the prospective course curriculum; and
assigning credit for prior learning to any course with an equivalent to the individual's work history, volunteer history and/or academic history.

2. The method of claim 1 wherein comparing the at least one of work history, volunteer history and/or academic history for the individual with a list of courses from a prospective course curriculum comprises:
parsing the at least one of work history, volunteer history and/or academic history for the individual;
generating embeddings based on words and sentences within the at least one of work history, volunteer history and/or academic history for the individual; and
comparing the embeddings with predetermined terms associated with the list of courses from the prospective course curriculum.

3. The method of claim 2 wherein comparing the embeddings with predetermined terms associated with the list of courses from the prospective course curriculum comprises:
determining a similarity between the embeddings and the predetermined terms.

4. The method of claim 3 wherein determining a similarity between the embeddings and the predetermined terms comprises:
calculating a cosine similarity score between the embeddings and the predetermined terms.

5. The method of claim 1 wherein assigning credit for prior learning to any course with an equivalent to the individual's work history, volunteer history and/or academic history comprises:
displaying results of equivalence comparison between the at least one of a work history, volunteer history and/or academic history for the individual and the course outcome for any of the list of courses from the prospective course curriculum;
receiving input confirming equivalence confirmation; and
assigning credit for prior learning based on input received.

6. The method of claim 1 wherein assigning credit for prior learning to any course with an equivalent to the individual's work history, volunteer history and/or academic history comprises:
assigning credit for prior learning if it is determined that there is equivalence between the individual's work history, volunteer history and/or academic history and course outcome for any of the list of courses from the prospective course curriculum.

7. The method of claim 1 further comprising:
updating the prospective course curriculum based on credit for learning determination.
